(19) United States
(12) Patent Application Publication
(10) Pub. No.: US 2023/0073632 A1
(43) Pub. Date: Mar. 9, 2023

(54) METHOD AND SYSTEM FOR TRANSPORTING HYDROGEN GAS VIA A PIPELINE

(71) Applicant: VSens Inc., San Jose, CA (US)

(72) Inventor: Janusz B. LIBERKOWSKI, Los Gatos, CA (US)

(21) Appl. No.: 17/467,058

(22) Filed: Sep. 3, 2021

(51) Int. Cl. F16L 9/18; F17D 1/02

(52) U.S. Cl. CPC F16L 9/18; F17D 1/02

(57) ABSTRACT

In the transportation of hydrogen using pipelines, existing oil and natural gas pipelines can be retrofitted with inner tubes defining an inter-space between the outer surface of the inner tubes and the pipelines, and providing a fluid at in the inter-space at a higher pressure than that of the hydrogen in carried in inner tube.

### FIELD OF THE INVENTION

The invention relates to the transportation of small atomic structure gases such as hydrogen via pipelines.

### BACKGROUND OF THE INVENTION

One of the main problems with hydrogen and helium storage is the minute size of the hydrogen molecule and the helium atom.

Since, at room temperature, under atmospheric pressure, hydrogen is a gas with a molecule comprising only two hydrogen atoms each with a single proton, hydrogen is highly permeable and has the tendency of escaping from the containers or tanks they are stored in. The same applies to helium which is made up of atoms, each with two protons.

The solution to this problem was describe in commonly-owned patent application PCT/US2019/063902 entitled Method and System for Containing a Small Atomic Structure Gas.

### SUMMARY OF THE INVENTION

The present application provides an implementation of the hydrogen containment system within a cylindrical housing such as a pipeline, by providing a method and inner housing configuration that allows an existing pipeline such as an oil or natural gas pipeline to be retrofitted for the containment and transport of hydrogen or other small-atomic structure gases.

For ease of reference all small atomic structure gases that tend to escape through the walls of their containers will be referred to herein as hydrogen but it will be understood that other small atomic structure gases such as helium are included and that the small atomic structure gas may at times be maintained in liquid or solid form depending on the temperature and the pressure.

According to the invention, there is provided a pipeline for small atomic structure gases such as hydrogen or helium, comprising a double-walled pipeline with an inner wall and an outer wall, wherein the outer wall is defined by an existing oil or natural gas pipeline, and the inner wall is defined by an inner tube that fits into the existing pipeline and is spaced by means of spacers from an inner surface of the pipeline to define an inter-space between the pipeline and the inner tube, and wherein the inner tube is made of a material that won't react physico-chemically with hydrogen or with a fluid that is fed into the inter-space.

The inner tube may be made of a material and wall thickness that is designed to withstand a desired pressure differential between that of the hydrogen housed within the inner tube, and the fluid in the inter-space.

Further, according to the invention there is provided a pipeline for small atomic structure gases such as hydrogen or helium comprising a double-walled pipeline with an inner wall and an outer wall, wherein the outer wall is defined by an existing oil or natural gas pipeline, and the inner wall is defined by an inner tube that fits into the existing pipeline and is spaced from the inner surface of the pipeline to define an inter-space between the pipeline and the inner tube, and wherein a fluid, other than a small atomic structure gas, is maintained in the inter-space at a higher pressure than the pressure of small atomic structure gas contained within the inner tube. The inner tube may be spaced from the pipeline by means of wheels supporting the inner tube. As discussed above, for ease of reference the small atomic structure gas will be referred to herein simply as hydrogen even though it may include other atomic and molecular structures that are small enough to escape through the walls of a container.

As discussed in application PCT/US2019/063902, the inner tube may be made of any suitable material that won't react physico-chemically with hydrogen or with the fluid in the inter-space and can withstand the pressure differential between that of the hydrogen housed within the inner tube, and the fluid in the inter-space. Similarly, the fluid chosen for the inter-space is chosen to be physically and chemically non-reactive (inert) with the existing pipeline (also referred to herein as the outer wall).

The fluid in the inter-space may be a gas or a liquid. For example, the gas in the inter-space may be nitrogen. The inner tube may be formed in sections wherein each tube section sealingly engages with the adjacent tube section. The tube sections may be made of a plastics material such as nylon, or of metal, e.g., steel. It will be appreciated that the wall thickness of the tube sections is chosen depending on the type of material and the pressure differential chosen for the pressure in the inter-space relative to the pressure in the inner tube.

Each tube section may have a first end portion (also referred to herein as a female end portion) defining a frusto-conical inner surface, and a second end portion (also referred to herein as a male end portion) defining a tapered frusto-conical outer surface for allowing adjacent tube section to engage complementarily with one another. The inner surface of the first end portion and the outer surface of the second end portion may be provided with annular flexible ribs or teeth to complementarily engage one another. The end portions may be made wholly or partially from a deformable material, e.g., plastics material such as nylon, or rubber. At least one of the end portions of two engaging tube sections may include a deformable seal, such as an O-ring or sleeve or gasket made from a deformable material, e.g., rubber, silicone, etc. Instead of the tube sections defining frusto-conical inner or outer surfaces at one or both of their ends, the tubes may be made of resiliently flexible material with the ends formed into complementarily engaging end-sections that clip together.

The tube sections may be supported on runners (also referred to herein as wheels), which serve both as spacers to space the inner tube from the pipeline, and to facilitate the process of retrofitting an existing pipeline with the inner tube. The wheels may be formed in or on sleeves that may be secured to the pipe sections.

Still further, according to the invention, there is provided a method of transporting hydrogen via a pipeline that includes an outer pipe and an inner tube defining an inter-space between them, comprising transporting the hydrogen within the inner tube, and providing a fluid in the inter-space that is at a higher pressure than the hydrogen in the inner tube.

Still further, according to the invention, there is provided a method for transporting hydrogen using an existing oil or natural gas pipeline, comprising retrofitting the pipeline with an inner tube that is spaced from the inner surface of the pipeline to define an inter-space between the inner tube and the pipeline, and is adapted to withstand a predefined differential pressure between the inner tube and the inter-space.

Still further, according to the invention, there is provided a method for transporting hydrogen using an existing oil or natural gas pipeline, comprising retrofitting the pipeline with an inner tube that is spaced from the inner surface of the pipeline to define an inter-space between the inner tube and the pipeline, transporting the hydrogen within the inner tube, and providing a fluid in the inter-space that is at a higher pressure than the hydrogen in the inner tube. The fluid may be a gas that does not include small atomic structures capable of permeating through the walls of the pipeline or inner tube. The retrofitting may include supporting the inner tube on wheels. The inner tube may be formed in tube sections and the retrofitting may include rolling one tube section into the pipeline one at a time and sealingly connecting the tube sections to one another. In a pipeline that defines at least one open end, a first tube section may be rolled into the open end all the way to the opposite end of the pipe with the help of a conveying device, e.g., a tractor or motorized sled (also referred to herein as a motorized vehicle) that fits into the pipeline, followed by the next tube section that is rolled into the pipe by means of the conveying device until said next tube section engages with the first tube section. Instead, insofar as the pipe permits access at both ends, the tube sections may be fed into the pipe and secured to one another as they are fed into the tube with a conveying device, e.g., a motorized vehicle, attached to the first tube section to pull the tube sections further into the tube as additional tube sections are added. The term “fluid” is used to cover any liquid or gas. The method may include connecting a pump to one end of the pipeline, wherein the pump includes an inner housing in flow communication with the inner tube, and an outer housing in flow communication with the pipeline. The method may further include providing a valve in the flow path of the inner tube to control the flow of hydrogen through the inner tube.

Further, according to the invention, there is provided a pump comprising an inner housing with means for connecting the inner housing to an inner tube of a pipeline so as to be in flow communication with the inner tube, wherein the pipeline comprises an outer pipe and an inner tube, the pump further comprising an outer housing that defines an inter-space between the inner housing and the outer housing, wherein the outer housing includes means for connecting the outer housing to the outer pipe to place the inter-space in flow communication with an inter-space between the outer pipe and the inner tube.

### BRIEF DESCRIPTION OF THE DRAWINGS

FIG. 1 is a cross-section through a gas pipeline that is being retrofitted in accordance with one embodiment of the invention,

FIG. 2 is a three-dimensional view of and one embodiment of an inner tube section for a gas pipeline in accordance with the invention,

FIG. 3 is a three-dimensional view of two interconnected inner tube sections of FIG. 2 for a gas pipeline in accordance with the invention,

FIG. 4 is a sectional side view of one embodiment of complementary end sections of two inner tube sections in accordance with the invention,

FIG. 5 is a sectional three-dimensional view of one embodiment of a manifold for feeding a first gas into the inter-space and hydrogen into the inner tube of a hydrogen pipeline of the invention,

FIG. 6 is a three-dimensional view of the manifold of FIG. 5,

FIG. 7 is an end view of the manifold of FIG. 5,

FIG. 8 is a three-dimensional view of one embodiment of a tractor for retrofitting a pipeline with inner tube sections,

FIG. 9 is a sectional three-dimensional view showing a tractor of FIG. 9 retrofitting a pipeline, and

FIG. 10 is a sectional three-dimensional view of one embodiment of a valve station and pump connected to the manifold of FIG. 5.

### DETAILED DESCRIPTION OF THE INVENTION

The present invention defines both a retrofitting solution for existing oil or natural gas pipeline to accommodate the transfer of hydrogen, as well as the formation of a new hydrogen-carrying pipeline.

As discussed in commonly owned patent application PCT/US2019/063902, in order to avoid or at least reduce the loss of hydrogen from a housing (in this case a pipeline), the housing needs to include an inner and an outer housing. In the case of an existing pipeline the outer housing is defined by the existing pipeline, while the inner housing is formed by a tube as discussed further in this patent application.

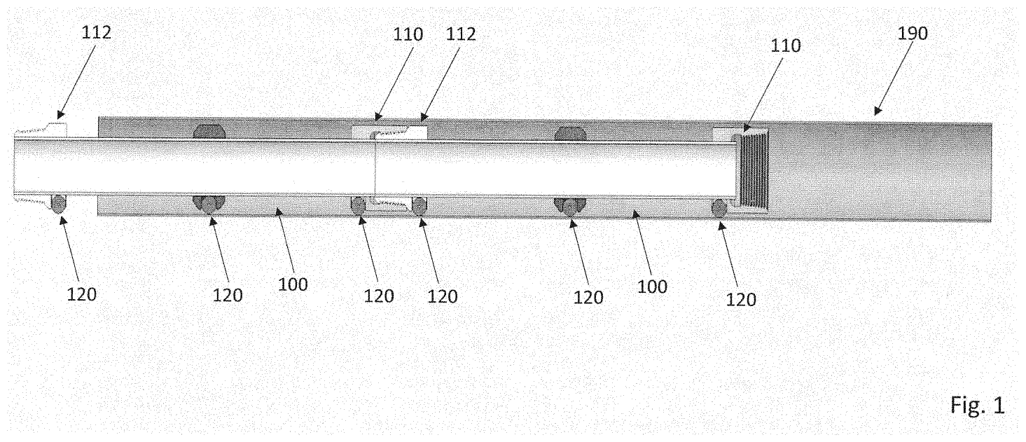

One embodiment of an inner tube of the invention is shown in FIG. 1. The inner tube in this embodiment is made up of sections 100, each section having a first end portion 110 and a second end portion 112. The first end portion 110 defines a frusto-conical inner surface with flexible ribs. The second end portion 112 comprises a tapered flexible portion with an outer ribbed surface, wherein the angle of the taper corresponds to the angle of the inner ribbed surface of the first end portion 110, so that the two portions 110, 112 complementarily engage one another.

Each section 100 is supported on runners 120 (also referred to herein generally as wheels). In this embodiment one set of runners 120 supports the first end portion 110, and a second set supports the second end portion 112. A third set of runners, in this embodiment, supports the middle of the tube section 100. It will be appreciated that depending on the material chosen for the tube sections and the length of the tube sections, additional sets of runners may have to be included in the design of each tube section. Similarly, in the case of short tube sections or tube section made of a rigid material, the middle set of runners in the FIG. 1, embodiment may be eliminated. The tube sections 100 may for example be made of metal or a plastics material.

As shown in FIG. 1, the tube 100 sections are place within an outer tube 190, which in a retrofitting solution comprises an existing pipeline, e.g. an oil or natural gas pipeline.

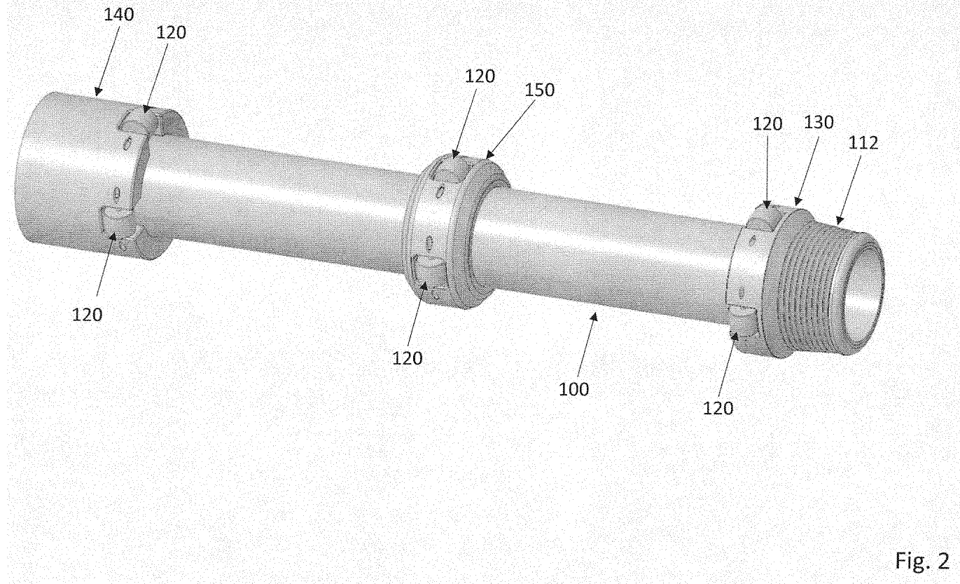

FIG. 2 shows a three-dimensional view of a tube section 100. As shown in FIG. 2, each set of wheels 120 is spaced around the perimeter of the tube section 100. The set of wheels that is secured adjacent the tapered end portion 112 is secured by means of a sleeve 130, which supports the wheels 120. In the case of the set of wheels 120 at the opposite end (the first end portion 110 with the frusto-conical inner surface), the sleeve 140 supporting the wheels 120 is formed integrally with the frusto-conical portion. The middle set of wheels is, in turn supported by a sleeve 150. The sleeves 130, 140, 150 may be secured to the tube section in any suitable manner, e.g., the sleeves may be split sleeves with tightening bolts and nuts, and may include a rubber seal between the sleeve and the tube section. The sleeves may instead be secured to the tube section by means of adhesive or any other suitable manner. It will also be appreciated that the wheels in another embodiment may be arranged to only support the lower portion of the tube sections.

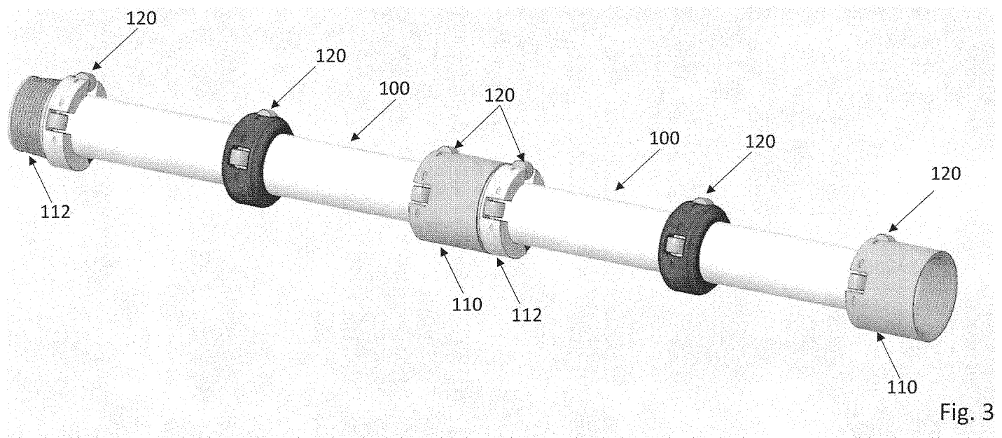

FIG. 3 shows two of the tube sections 100 of the FIG. 2 embodiment, joined together.

In the above embodiments the annular ribs defining the inner surface of the first end portion 110, and the outer surface of the tapered second end portion 112 could be configured to take any suitable shape to complementarily engage with one another.

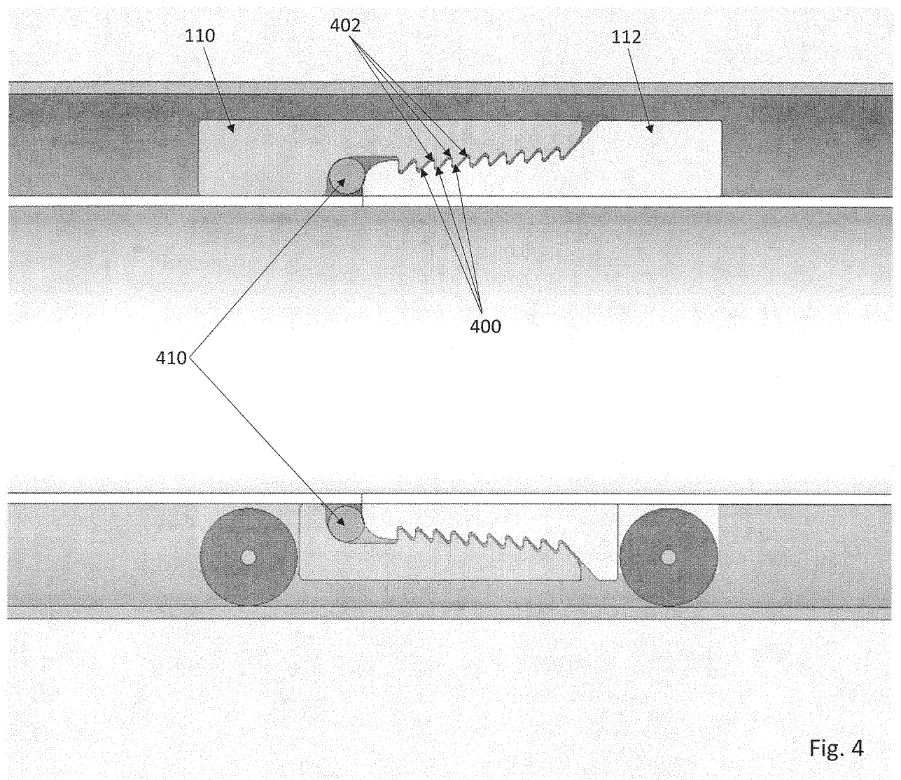

In the embodiment of FIG. 4, the ribs are configured as complementarily engaging teeth 400, 402. The teeth in this embodiment are angled to define a taper when viewed from the opening of a tube section. This teeth configuration is therefore also referred to herein as a tapered barb connection. The teeth 400, 402 may be lined by a sealing gel or sealing layer, e.g., silicone gel, or silicone coating, respectively to provide a better sealing engagement between the teeth. In this embodiment, the first end portion 110 is also provided with an O-ring that provides an additional seal between the two end portions 110, 112.

Once the inner tube has been placed in the pipeline, a fluid, e.g., an inert gas such as nitrogen or CO2 is fed into the inter-space between the inner tube and the pipeline to a pressure that the pipeline can accommodate, e.g., 85 bar. The use of nitrogen or CO2 in the inter-space also helps avoid fires.

Insofar as the inner tube is made of a highly deformable material, e.g., thin-walled plastics material such as nylon, buckling of the inner tube due to the pressure differential can be avoided by simultaneously feeding the hydrogen into the inner tube. As discussed above, an in more detail in commonly-owned patent application PCT/US2019/063902, the gas in the inter-space has to be maintained at a higher pressure than that of the hydrogen in the inner tube to avoid or at least reduce the loss of hydrogen through the walls of the inner tube. Thus, the hydrogen could for instance be fed in at a pressure of 80 bar while nitrogen if fed into the inter-space at 85 bar.

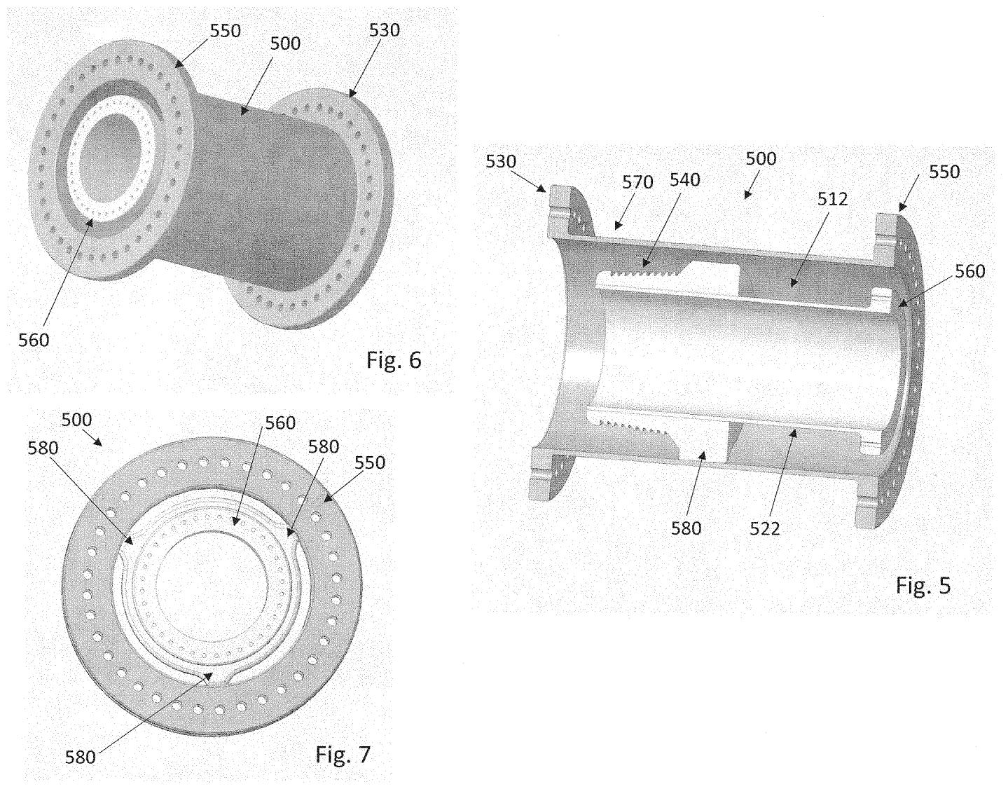

FIGS. 5 to 7 show an embodiment of a manifold 500 attachable to the pipeline and inner tube. The manifold 500 in this embodiment connects to the pipeline 190 (FIG. 1) by means of a clamp and seal arrangement as defined by a first outer flange 530, and it connects to the inner tube by means of a tube adaptor 540 (FIG. 5) having a configuration to complementarily engage the end portion of the last pipe section (in this case the tube adaptor 540 is a male adaptor to couple with a female end portion (also referred to herein as a first end portion 110). Thus, it will be appreciated that in this configuration, the tube sections were placed into the pipeline with the second end portions 112 leading, which is opposite to the process depicted in FIG. 1.

The opposite end of the manifold 500 includes a second outer flange 550 and an inner flange 560. Flanges 550, 560 allow the manifold 500 to be coupled to air supply sources (e.g., gas pumps (not shown)) to supply the hydrogen to the inner tube via the inner housing 522, and supply the higher pressure fluid (e.g., nitrogen) to the inter-space between the inner tube and the pipeline via the inter-space 512 of the manifold between the inner housing 522 and outer housing 570 of the manifold.

As shown in FIG. 7, the inner tube with its flange 560 is spaced from the outer housing 570 (FIG. 5) of the manifold (which attaches to the pipeline) by means of ribs 580.

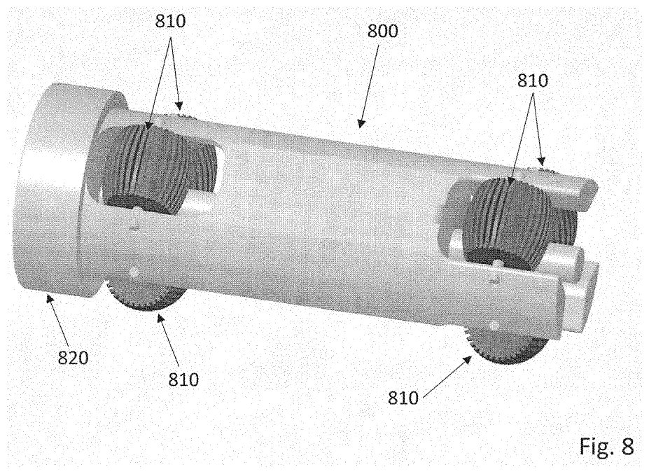

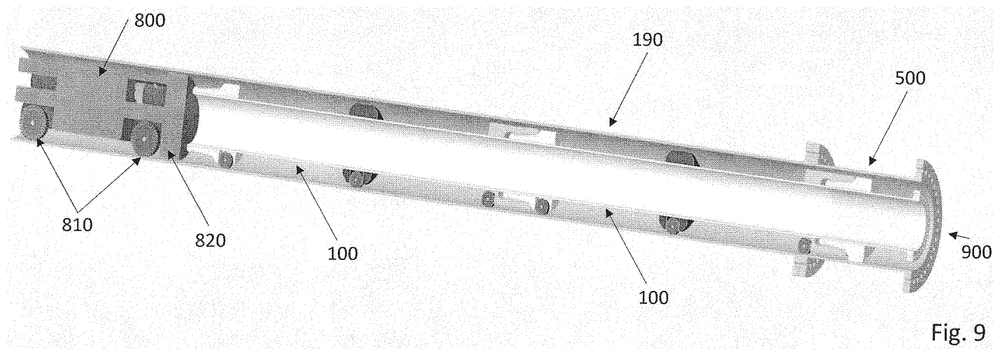

In practice, in order to retrofit an existing pipeline, one embodiment discussed in this application involves pushing tube sections 100 to the end of the pipeline or pipeline section and then pushing the next tube section 100 down the pipeline to engage with the first tube section. One embodiment for achieving this involves the use of a self-propelled tractor or sled 800, shown in FIG. 8, which is provided with wheels 810, which are connected to an electric motor (not shown) to drive the tractor into the pipeline, pushing the successive tube sections 100 by means of pushing head 820 into the pipeline 190 as shown in FIG. 9. In the embodiment of FIG. 9, the manifold 500 is shown at the distal end 900 of the pipeline.

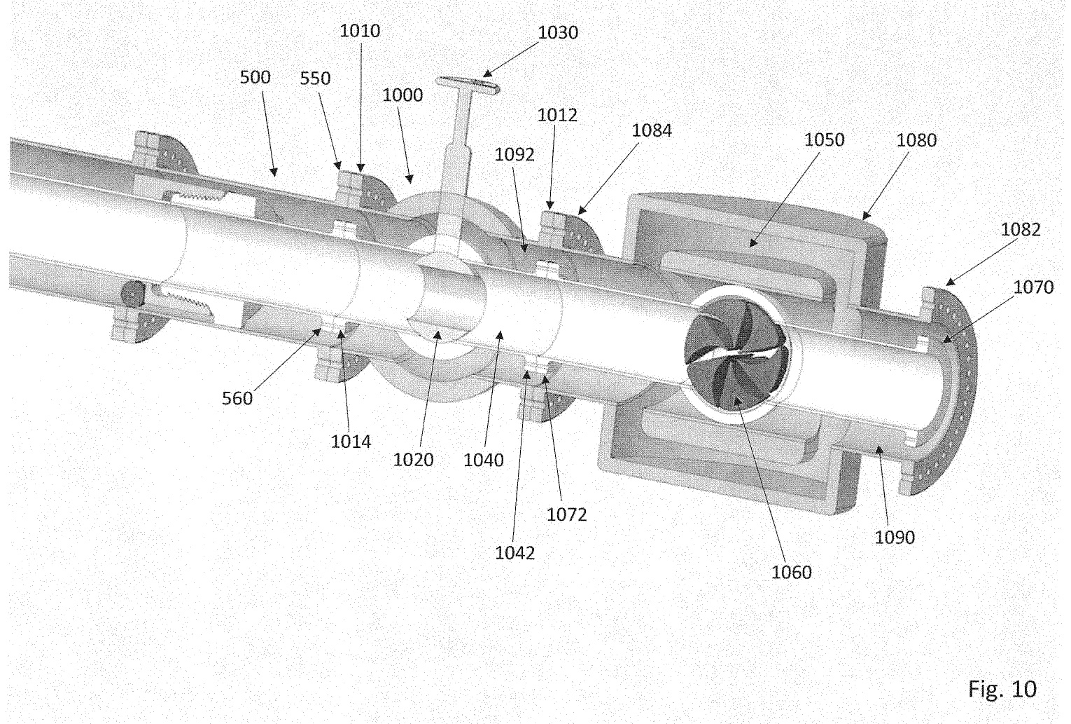

One embodiment for connecting an gas supply source to the manifold 500, is shown in FIG. 10. In this embodiment, the manifold 500 is attached to a valve station 1000, which is secured to the manifold 500 by means of a flange 1010 that is bolted to abutting flange 550 of the manifold, and by means of an inner flange 1014 which is bolted to the flange 560 of the manifold. The valve station includes a rotatable valve 1020 that is manually rotatable via a wheel 1030, in order to either open or close the flow path to hydrogen (or other small atomic structure gas) that is pumped into the valve chamber 1040. It will be appreciated that even though the present embodiment discusses the use of flanges for connecting the manifold 500 to the valve station and for connecting the valve station to the inner tube and pipeline, the various elements could be connected using other connection means, e.g., in the case of flexible tubes sections, stainless steel ratcheting clamps may be used to connect the pump to the tube section or to the valve station.

In this embodiment, the gas supply into the valve chamber 1040 is provided via a pump 1050 that includes an impeller 1060. A hydrogen source is connected to the pump 1050 by bolting the source to a flange 1070. The outlet from the pump 1050 is, in turn, connected to the valve chamber 1040 by means of a flange 1072 that is bolted to the valve chamber by means of a flange 1042. The outlet from the valve chamber 1040 is in turn connected to the flange 560 of the manifold by means of a flange 1044.

The pump 1050 is surrounded by a second housing 1080, which defines a flow path for fluid (e.g., nitrogen) into the inter-space between the inner tube and the pipeline. For instance, a nitrogen source is coupled to the flange 1082 by providing the nitrogen source (not shown) with a complementary flange that bolts onto the flange 1082. The opposite end of the outer housing 1080 includes an outlet pipe with flange 1084 that is bolted onto a complementary flange 1012 at the inlet to the valve station. Nitrogen can thus flow through the inter-space 1090 between the pump 1050 and outer housing 1080, and pass into the inter-space 1092 of the valve station, and from there into the inter-space 512 of the manifold 500, and on to the inter-space between the pipeline and the inner tube. This allows the inter-space to be pressurized to the desired pressure with nitrogen or other non-reactive, large atomic structure fluid. Once the inter-space is filled with nitrogen the pressure is maintained at a level that does not exceed the strength capabilities of the pipeline, but is higher than the pressure of the hydrogen that is fed down the inner tube. As discussed above, the pressurization of the inter-space may be done at the same time as hydrogen is fed into the inner tube, thereby avoiding excessive pressure differentials between the inner and outer surfaces of the inner tube.

For ease of reference, the units supplying the fluid and hydrogen (in this case the valve station and the pump) are referred to collectively as the supply system. To avoid hydrogen leakage from the supply system, the supply system preferably also defines a double walled housing with an inner housing in flow communication with the inner tube, and an outer housing defining a housing inter-space between the inner and outer housings, which is in flow communication with the inter-space between the pipeline and the inner tube

The above embodiments specifically discussed the retrofitting of existing pipelines in order to transport hydrogen. It will be appreciated that a similar configuration can be used for creating new pipelines made specifically for the transportation of hydrogen. However, in this latter configuration, the pipeline can be formed in sections similar in length to the tube sections 100. Also, the need for wheels 120 can be avoided provided that spacers are provided between each pipe section and tube section to define the inter-space.

While the present invention has been described with respect to specific embodiments, it will be appreciated that different configurations and adaptations to the various pipe sections and their features can be made without departing from the scope of the invention.

What I claim is:

1. A pipeline for small atomic structure gases such as hydrogen or helium, comprising
a double-walled pipeline with an inner wall and an outer wall, wherein the outer wall is defined by an existing oil or natural gas pipeline, and the inner wall is defined by an inner tube that fits into the existing pipeline and is spaced by means of spacers from an inner surface of the pipeline to define an inter-space between the pipeline and the inner tube, and wherein the inner tube is made of a material that won't react physico-chemically with hydrogen or with a fluid that is fed into the inter-space.

2. The pipeline of claim 1, wherein the spacers comprise wheels supporting the inner tube.

3. The pipeline of claim 1, wherein the inner tube is made of a material and wall thickness that is designed to withstand a desired pressure differential between that of the hydrogen housed within the inner tube, and the fluid in the inter-space.

4. The pipeline of claim 3, wherein the fluid fed into the inter-space is chosen to be physico-chemically non-reactive (inert) with the existing pipeline.

5. The pipeline of claim 1, wherein the inner tube is formed in sections wherein each tube section sealingly engages with adjacent tube sections.

6. The pipeline of claim 5, wherein the tube sections are made of a plastics material or metal.

7. The pipeline of claim 5, wherein each tube section has a first end portion and a complementary second end portion, wherein the end portions of adjacent tube sections are configured to sealingly engage with one another.

8. The pipeline of claim 7, wherein each tube section has a first end portion (also referred to herein as a female end portion) defining a frusto-conical inner surface, and a second end portion (also referred to herein as a male end portion) defining a tapered frusto-conical outer surface for allowing adjacent tube section to engage complementarily with one another.

9. The pipeline of claim 8, wherein the inner surface of the first end portion and the outer surface of the second end portion are provided with flexible ribs or teeth to complementarily engage with one another.

10. The pipeline of claim 7, wherein at least one of the end portions is made wholly or partially from a flexibly deformable material.

11. The pipeline of claim 7, wherein at least one of the end portions of two engaging tube sections includes a deformable seal.

12. The pipeline of claim 1, further comprising a supply system for feeding hydrogen into the inner tube and a fluid into the inter-space, the supply system defining a double walled housing with an inner housing in flow communication with the inner tube, and an outer housing defining a housing inter-space between the inner and outer housings, which is in flow communication with the inter-space between the pipeline and the inner tube.

13. A method of transporting hydrogen via a pipeline that includes an outer pipe and an inner tube defining an inter-space between them, comprising:
transporting the hydrogen within the inner tube, and providing a fluid in the inter-space that is at a higher pressure than the hydrogen in the inner tube.

14. The method of claim 13, wherein the fluid is a gas that does not include small atomic structures capable of permeating through the walls of the pipeline or inner tube.

15. A method for transporting hydrogen using an existing oil or natural gas pipeline, comprising:
retrofitting the pipeline with an inner tube that is spaced from the inner surface of the pipeline to define an inter-space between the inner tube and the pipeline, and is adapted to withstand a predefined differential pressure between the inner tube and the inter-space.

16. The method of claim 15, wherein the retrofitting includes supporting the inner tube on wheels.

17. The method of claim 15, wherein the inner tube is formed in tube sections and the retrofitting includes rolling one tube section into the pipeline one at a time and sealingly connecting the tube sections to one another.

18. The method of claim 17, wherein the tube sections are rolled into the pipeline using a motorized vehicle that fits into the pipeline.

19. The method of claim 15, further comprising connecting a pump to one end of the pipeline, wherein the pump includes an inner housing in flow communication with the inner tube, and an outer housing in flow communication with the pipeline.

20. The method of claim 19, further comprising providing a valve in the flow path of the inner tube to control the flow of hydrogen through the inner tube, wherein the valve is defined by a double-walled valve station with an inter-space between the two walls, which is in flow communication with the inter-space between the inner tube and the pipeline, the inner housing being connected in flow communication with the inner tube.

21. A pump comprising an inner housing with means for connecting the inner housing to an inner tube of a pipeline so as to be in flow communication with the inner tube, wherein the pipeline comprises an outer pipe and an inner tube spaced from the outer pipe to define a pipe inter-space between the outer pipe and the inner tube, the pump further comprising an outer housing that defines a pump inter-space between the inner housing and the outer housing, wherein the outer housing includes means for connecting the outer housing to the outer pipe to place the pump inter-space in flow communication with the pipe inter-space.
